(19) United States
(12) Patent Application Publication
(10) Pub. No.: US 2002/0157073 A1
(43) Pub. Date: Oct. 24, 2002

(54) Reducing capacitive interference in integrated circuits

(76) Inventor: Suresh Krishnamoorthy, Sunnyvale, CA (US)

Correspondence Address: HAMILTON & TERRILE, LLP, P. O. Box 203518, Austin, TX, 78759, US

(21) Appl. No.: 09/839,453

(22) Filed: Apr. 20, 2001

(51) Int. Cl. G06F 17/50

(52) U.S. Cl. 716/10; 716/1; 716/18

(57) ABSTRACT

The disclosure teaches reducing capacitive interference (also referred to as the Miller effect) in an integrated circuit having at least two conductors. One repeater is located on a first conductor and two repeaters are located on a second conductor. The two repeaters on the second conductor are located to on each side of the repeater on the first conductor. Locating the two repeaters on the second conductor on each side of the repeater on the first conductor balances or offsets the capacitive effect. In an embodiment, two repeaters on the second conductor are spaced substantially equidistantly from one repeater on the first conductor.

An embodiment of the invention reduces the Miller effect. In one embodiment the integrated circuit can be the memory or the central processing unit of a computer system. In another embodiment the integrated circuit is included in a computer system.

### BACKGROUND OF THE INVENTION

1. Field of the Invention

The invention relates to reducing capacitive interference between adjacent conductors on an integrated circuit. More specifically, the invention relates to spacing repeaters, such as inverters, on adjacent conductors.

2. Description of the Related Art

It is known to manufacture an integrated circuit using conductors separated by a semiconductor. Circuits are fabricated on a semiconductor by selectively altering the conductivity of the semiconductor material. Various conductivity levels correspond to elements of a transistor. Transistors, diodes, resistors, and small capacitors are formed on small chips of silicon. Individual components are interconnected by wiring patterns (typically aluminum or gold) that resemble ordinary printed circuit wiring. Integrated circuits are then mounted on etched circuit boards which are used to assemble electronic systems such as personal computers and other data processing equipment.

It is known that adjacent or parallel conductors create interference due to capacitive effects. For example, referring to FIG. 1A, both conductors carry signals in the same direction. As illustrated in FIG. 1A, the signal from the conductor labeled aggressor causes a capacitive effect in the signal labeled as the victim. This induced effect causes the signal in the victim conductor to increase its speed. The increased speed of the signal in the victim conductor is illustrated by comparing the original signal to the signal resulting from the capacitive interference as further shown on FIG. 1A. The capacitive interference depicted is referred to as the “Miller effect” and can be quantified by a term referred to as the Miller coefficient. In the case shown in FIG. 1A the Miller coefficient is one.

Now referring to FIG. 1B, two aggressor conductors carrying signals in the same direction as the single victim conductor. In this case, two parallel conductors increase the interference in the signal in the victim conductor. FIG. 1B further illustrates the increased interference due to two aggressor conductors using a plot comparing the original signal and the signal as affected by the increased capacitive interference. As previously explained, the increased interference is known as the “Miller effect” and is quantified by the Miller coefficient. In the case shown in FIG. 1B the Miller coefficient is two.

Now referring to FIG. 2, the two conductors in FIG. 2A, (victim and aggressor) carry signals in the opposite direction. As shown in FIG. 2A, the effect of interference from a conductor carrying a signal in the opposite direction is to slow down the signal in the victim conductor. Now referring to FIG. 2B, the two aggressor conductors carry signals in the opposite direction from the victim conductor. As show in FIG. 2B, the effect of two aggressor conductors carrying signals in the opposite direction is to increase the delay in the victim signal. In the case shown in FIG. 2B the Miller coefficient is negative two.

In the design and manufacture of integrated circuits it is also known to use a repeater (or buffer) to amplify a signal. When a conductor is relatively long a signal will degrade due to resistive losses. Inserting a repeater in a conductor amplifies the signal to compensate for any resistive losses. Refer now to FIG. 3. As illustrated in FIG. 3, repeaters may be placed in adjacent positions.

It is known that repeaters will reverse the polarity of a signal. For example, a signal that switches from one to zero will switch from zero to one after passing through a repeater. As shown in FIG. 3 both aggressor and victim signals switch from zero to one after passing through a repeater. FIG. 3 also illustrates circumstances causing the signal to arrive earlier than predicted. As shown in FIG. 3, the effects of two aggressor signals combined with the effect of the parallel switching are cumulative causing the victim signal to arrive earlier than if only one condition existed.

As shown in FIG. 3 the signals in the aggressor and victim conductors may be opposite. When the signals in the aggressor and victim conductors switch in opposite directions, an additional delay is caused by the capacitive interference. The delay caused by capacitive interference is cumulative with the delay caused by more than one aggressor. The cumulative delays can cause errors in predicting the arrival time of the signal carried by the victim conductor.

As shown above capacitive interference is can increase or decrease depending on the placement of repeaters. What is needed is a technique to reduce the capacitive interference. In many cases eliminating the capacitive interference is the preferred result. In these cases the Miller coefficient will be zero.

### SUMMARY OF THE INVENTION

The disclosure teaches reducing capacitive interference (sometimes referred to as the Miller effect) in an integrated circuit having at least two conductors. One repeater is located on a first conductor and two repeaters are located on a second conductor. The two repeaters on the second conductor are located to on each side of the repeater on the first conductor. Locating the two repeaters on the second conductor on each side of the repeater on the first conductor balances or offsets the capacitive effect. Balancing the capacitive effect alternately speeds up and slows down the signal in the first conductor. By speeding-up then slowing down the signal the capacitive effect is offset, or reduced. Reducing the capacitive effect causes the signal to arrive more nearly at the time expected.

In an embodiment, two repeaters on the second conductor are spaced substantially equidistantly from one repeater on the first conductor. Substantially equidistant spacing of the repeaters allows the capacitive effects of the two repeaters to balance the capacitive effect than if the repeaters are substantially not equidistant.

In one embodiment the integrated circuit can be the memory or the central processing unit of a computer system. In another embodiment the integrated circuit is included in a computer system.

Two repeaters on the second conductor are spaced equidistantly from one repeater on the first conductor. Another embodiment teaches one repeater on the first conductor and two repeaters on the second conductor. The two repeaters on the second conductor are located to on each side of the repeater on the first conductor. Locating the two repeaters on the second conductor on each side of the repeater on the first conductor balances or offsets the capacitive effect. In this embodiment the repeaters on the second conductor are not equidistant but are located on opposing sides of a repeater on an adjacent conductor.

The disclosure also teaches a method for designing and manufacturing an integrated circuit to reduce capacitive interference. In this embodiment the integrated circuit can be the memory or the central processing unit of a computer system. In another embodiment the integrated circuit is included in a computer system. Another embodiment of the disclosure teaches a method for designing and manufacturing an electrical circuit to reduce capacitive interference.

Another embodiment of the invention reduces, or eliminates, the Miller effect. The Miller effect can be quantified in terms of the Miller coefficient. The Miller coefficient can be positive or negative. The absolute value of the Miller coefficient reflects the relative strength of the capacitive interference. A Miller coefficient of zero corresponds to a capacitive interference which has been eliminated. In this embodiment the Miller effect can be reduced by placement of repeaters on adjacent conductors.

The foregoing is a summary and this contains, by necessity, simplifications, generalizations and omissions of detail; consequently, those skilled in the art will appreciate that the summary is illustrative only and is not intended to be in any way limiting.

### BRIEF DESCRIPTION OF THE DRAWINGS

The present invention may be better understood, and its numerous objects, features, and advantages made apparent to those skilled in the art by referencing the accompanying drawings.

FIG. 1A illustrates capacitive interference in two adjacent conductors. FIG. 1B illustrates capacitive interference in three adjacent conductors. The signals in FIGS. 1A and 1B are in the same direction on the aggressor and victim conductors.

FIG. 2A illustrates capacitive interference in two adjacent conductors having signals in opposite directions. FIG. 2B illustrates capacitive interference in three adjacent conductors having signals in opposite directions.

FIG. 3 illustrates placing of repeaters in adjacent locations in parallel conductors. FIG. 3 further illustrates the effects of repeaters on switching when the aggressor and victim signals switch in the same and in opposite directions.

FIG. 4 illustrates placing repeaters equidistant on parallel conductors. FIG. 4 illustrates the effects of equidistant spacing of repeaters when the aggressor and victim signals switch in the same direction and when the aggressor and victim signals switch in opposite directions.

FIGS. 5A AND 5B illustrates placing repeaters on parallel conductors. FIGS. 5A and 5B illustrate the effects of repeaters which are not equidistantly spaced.

FIG. 6 is a block diagram of a computer system. The computer system incorporates various components (central processing unit, memory, etc.) which are integrated circuits which may be fabricated using the method taught.

The use of the same reference symbols in different drawings indicates identical items unless otherwise noted.

### DETAILED DESCRIPTION

The following sets forth a detailed description of a mode for carrying out the invention. Although the description refers to designing integrated circuits the invention is also applicable to the manufacture and assembly of integrated circuits. The description is intended to be illustrative of the invention and should not be taken to be limiting.

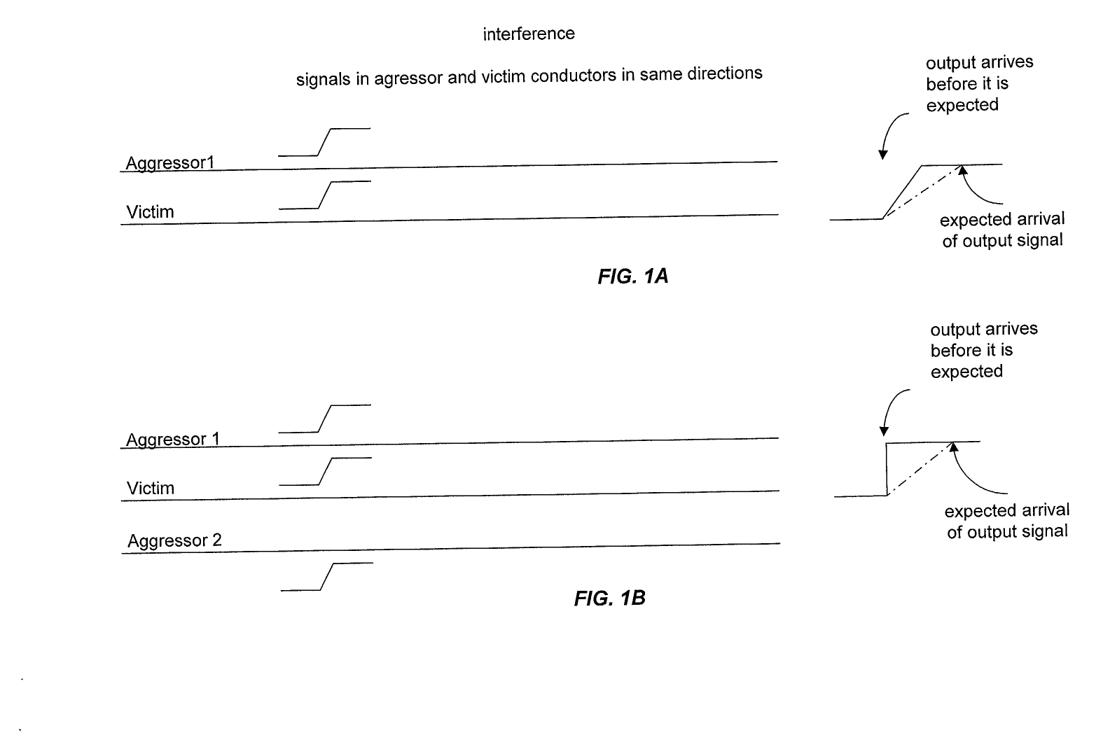

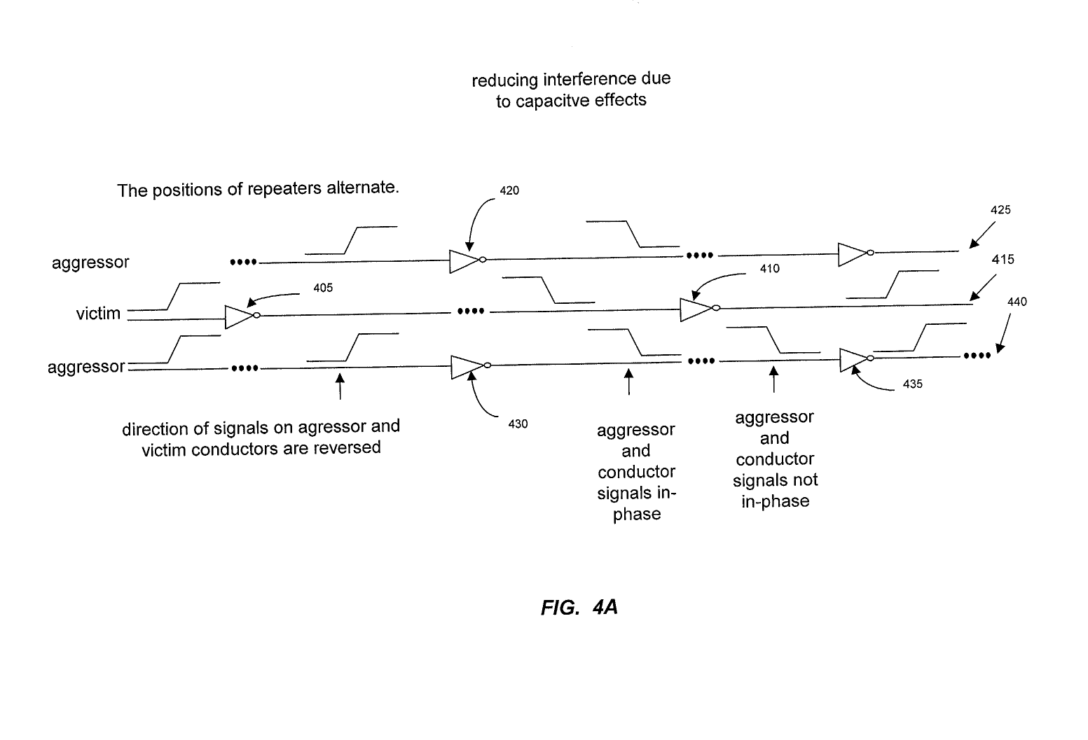

As illustrated in FIGS. 1, 2 and 3 current flowing in a conductor causes capacitive interference in adjacent conductors. The amount of interference increases with the number of adjacent conductors. The amount of interference also increases with the proximity of a repeater to an adjacent conductor. Capacitive interference is reduced by placing repeaters before and after repeaters on an adjacent conductor.

For example, the disclosure teaches reducing the interference by locating a repeater equidistant from repeaters on adjacent conductors. By locating a repeater on a conductor to be equidistant from repeaters on an adjacent conductor the capacitive interference of the two repeaters are offset as shown in the figures below. However, the repeaters need not be equidistant to reduce capacitive interference. Capacitive interference is reduced by first increasing then decreasing the speed of a signal in an adjacent conductor.

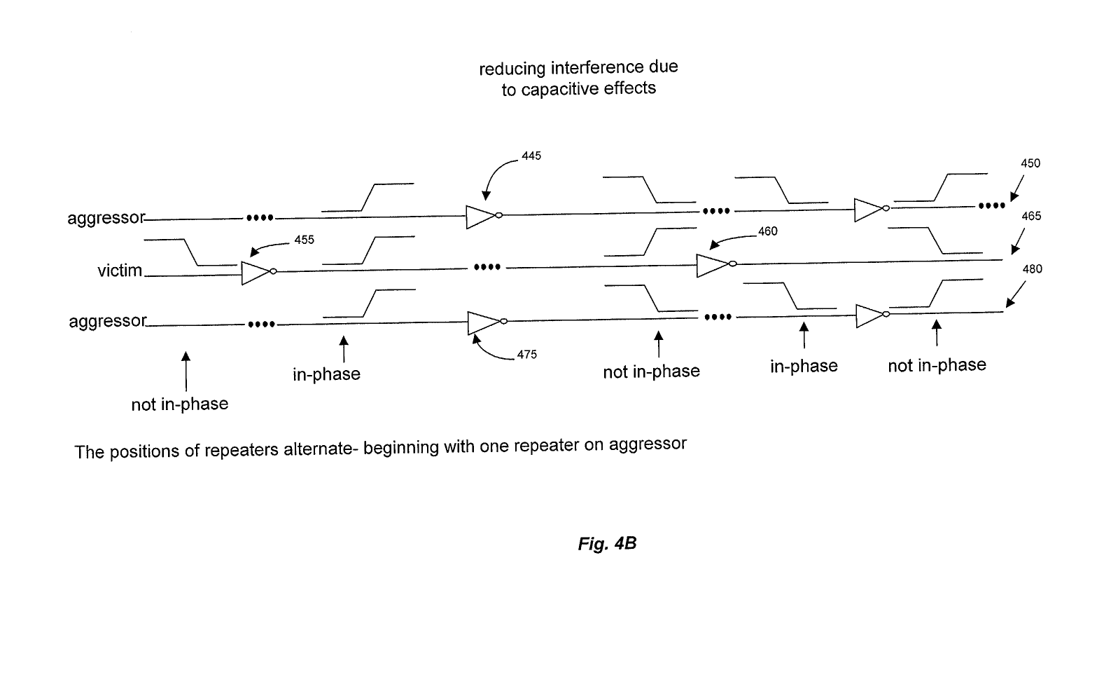

FIGS. 4A and B illustrate two cases involving three conductors. FIG. 4A illustrates a case in which the signals on the aggressor and victim conductors switch in the same direction. Signals which switch in the same direction are sometimes referred to as “in-phase.” To reduce the capacitive interference repeater 405 and 410 are located on victim conductor 415. Accordingly, repeater 420 is located on aggressor conductor 425 equidistant from repeaters 405 and 410. Locating repeater 420 on aggressor conductor 425 equidistant from repeaters 405 and 410 maximizes the distance between repeaters 405, 410 and repeater 420, and thus minimizes the interference. Similarly, repeater 430 and repeater 435 on conductor 440 are located equidistant from repeater 410. Locating repeaters 430, 435 equidistant from repeater 410 reduces the capacitive interference from conductor 440 to conductor 415.

Still referring to FIG. 4A, when switching signals on the aggressor and victim conductor begin out-of-phase then the signal on victim conductor becomes in-phase after the first repeater. As shown previously (refer to FIG. 1A), the effect of two aggressor signals in-phase with a victim signal is to increase the speed of the signal. Thus the victim signal arrives at its terminal faster than predicted. In many applications a signal arriving sooner than predicted is acceptable but in a few situations a signal arriving earlier than predicted can cause operational defects. By aligning the repeaters so that signals are maintained out-of-phase, the victim signal arrives more nearly at the predicted time.

Now referring to FIG. 4B, the signals in the victim and aggressor conductors are more nearly maintained in-phase by strategic placement of repeaters. FIG. 4B illustrates a system in which the signals on the victim and aggressor conductors are initially out-of-phase. (Of course this can be the same system as earlier illustrated in FIG. 4A, but modified with the simple insertion of one repeater on the victim conductor which reverses the signal in victim conductor, thus creating the scenario in FIG. 4B.) Once the aggressor and victim signals are not in-phase the signals may be thus maintained by placing the repeaters on the victim conductor equidistant from a repeater on the aggressor conductor. As shown in FIG. 4B, the signals are maintained out-of-phase by placing repeaters 455, 460 on conductor 465 equidistant from repeater 445 on conductor 450. Similarly, repeater 475 on conductor 480 is placed equidistant from repeaters 455, 460.

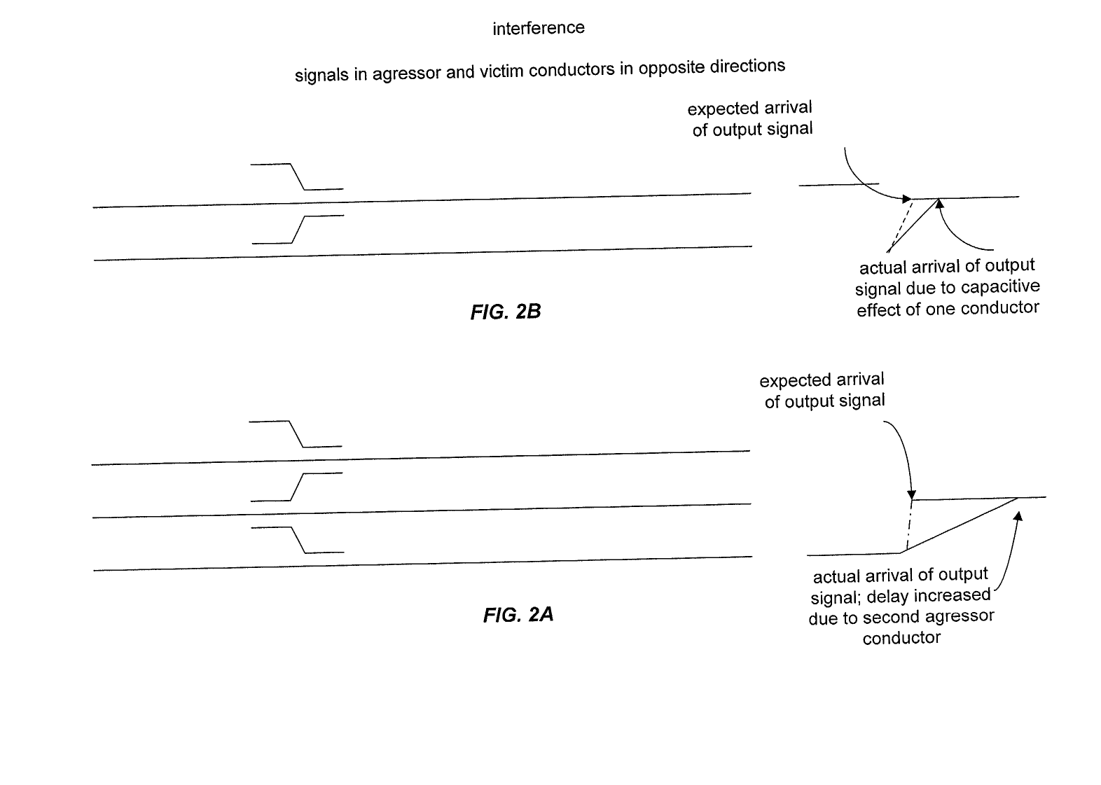

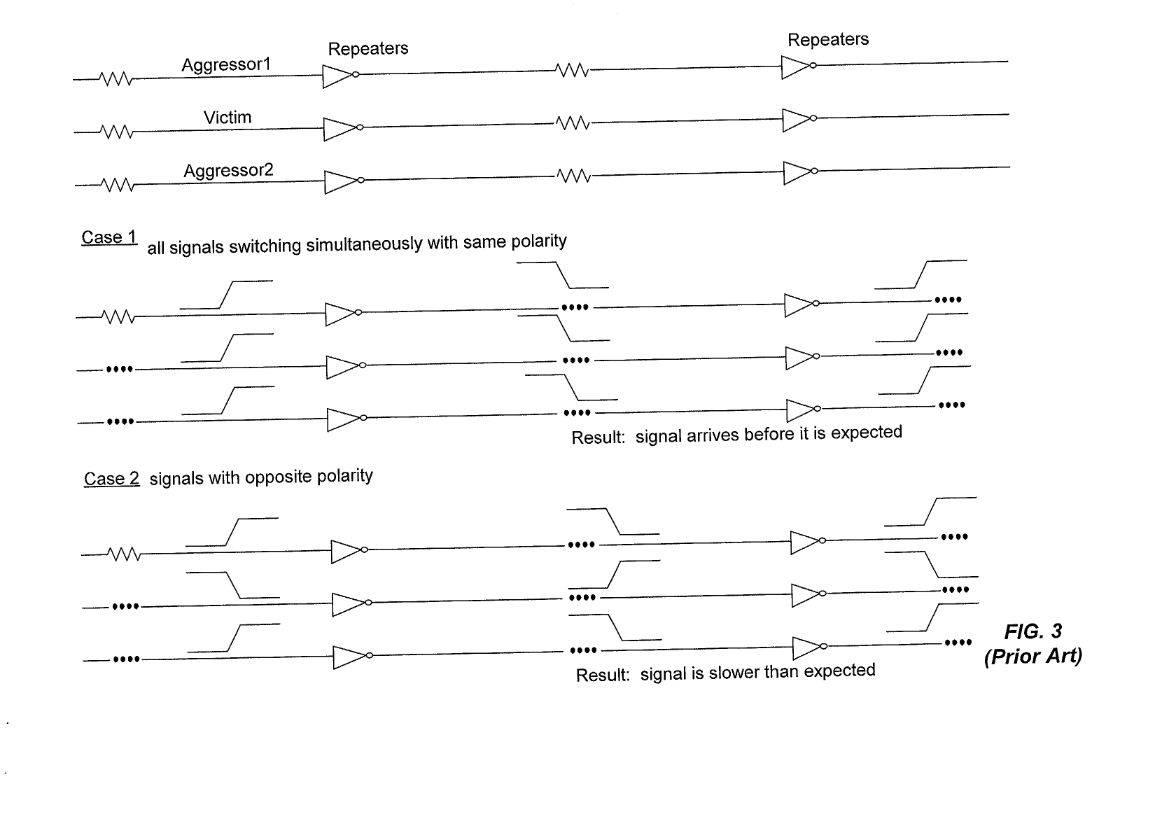

Maintaining the signals out-of-phase allows the aggressor signals to alternately increase and decrease the speed of the victim signal. Alternately increasing and decreasing the speed of the victim signal (see FIGS. 1 and 2) decreases the cumulative effect of the interference, in effect balancing or neutralizing the capacitive interference. Decreasing the cumulative effect of the interference allows the victim signal to arrive more nearly at the predicted time. The victim signal arriving more nearly at the predicted time allows the system to work as designed and produce the expected result.

Thus, as shown in FIG. 4A, repeaters can be located to cause signals in adjacent conductors to be reversed. On the left hand side of FIG. 4A, the signal in each of the aggressor and victim conductors are in-phase. Repeater 455 reverses the polarity of the signal in the victim conductor. Repeaters 445 and 450 on aggressor conductor are placed on either side of repeater 460 on the victim conductor. Placing repeater 445 and 450 as shown maintains the signals in the aggressor conductor and victim conductor out-of-phase. Placing repeaters 445 and 450 as shown also alternately speeds up and slows down the signal in the victim conductor. Alternately speeding up and slowing down the signal in the victim conductor minimizes the capacitive effect.

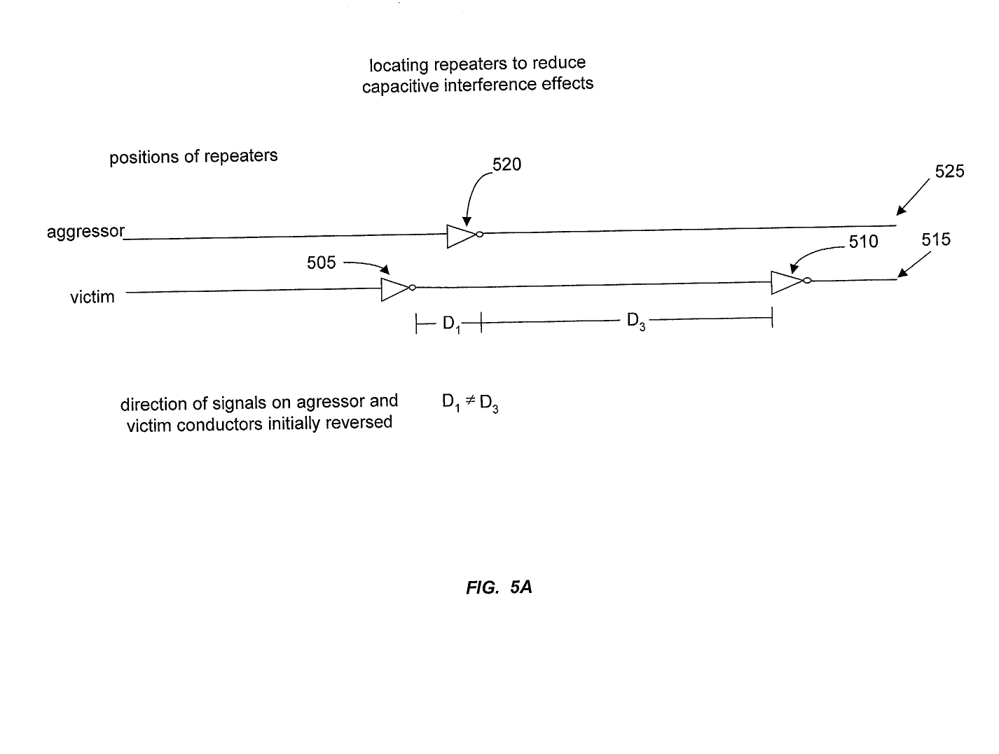

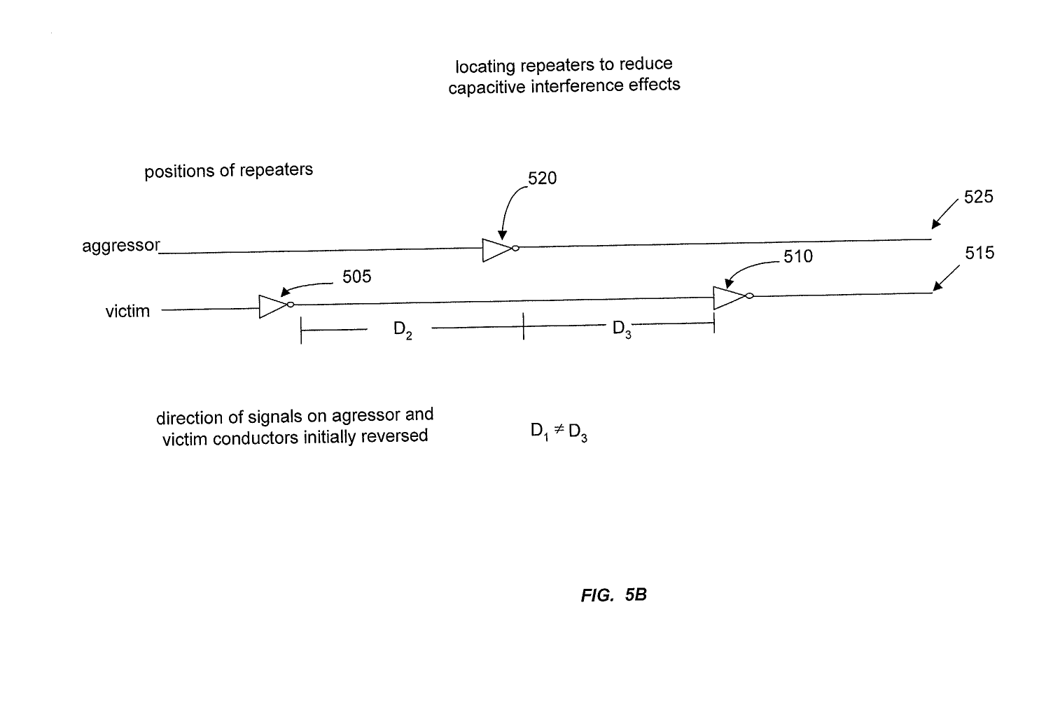

FIGS. 5A and 5B illustrates that the repeaters need not be equidistantly spaced to reduce the capacitive effect. Referring to FIG. 5A, repeater 520 is placed at a location on aggressor conductor 525. Repeaters 505 and 510 are placed on victim conductor 515. The distance from repeater 505 to repeater 520 is labeled D₁. The distance from repeater 520 to repeater 510 is labeled as D₃. As noted, D₁ does not equal D₃. However, the capacitive interference is reduced by locating repeaters 505 and 510 on opposite sides of repeater 520.

Now referring to FIG. 5B, repeater 520 is again placed on aggressor conductor 525. Repeaters 505 and 510 are placed on victim conductor 515. However, the distance from repeater 505 to repeator 520 (previously labeled D₁) is now increased and is labeled D₂. In this illustration D₂ again does not equal D₃. However D₂ is greater than D₁ and more nearly equals D₃ than as shown in FIG. 5A. Thus, although the repeaters are not placed equidistantly, the capacitive interference is reduced from FIG. 5A to FIG. 5B by placing repeaters 505 and 510 on opposing sides of repeater 520 and increasing the distance from repeater 505 to repeater 520 to approximate the distance from repeater 520 to repeater 510.

### An Example of a Computer System

The present disclosure is applicable to any integrated circuit including data processing systems. Integrated circuits may be found in many components of a typical computer system, for example a central processing unit, memory, cache, audio controller, network interface, I/O controller and I/O device as shown in the example below. Integrated circuits are found in other components within a computer system such as a display monitor, keyboard, floppy and hard disk drive, DVD drive, CD-ROM and printer. However, the example of a computer system is not taken to be limiting. Integrated circuits are ubiquitous and are found in other electrical systems such as stereo systems and mechanical systems including automobiles and aircraft.

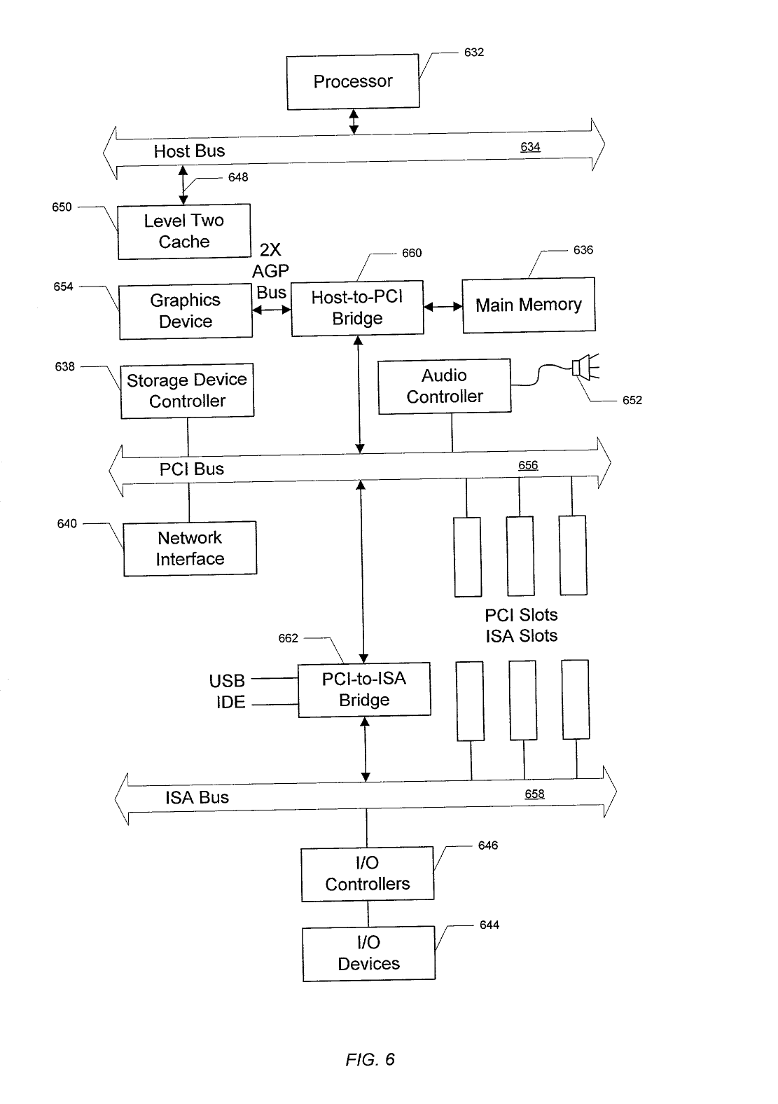

Referring to FIG. 6, computer system 630 includes central processing unit (CPU) 632 connected by host bus 634 to various components including main memory 636, storage device controller 638, network interface 640, audio and video controllers 642, and input/output devices 644 connected via input/output (I/O) controllers 646.

Typically computer system 630 also includes cache memory 650 to facilitate quicker access between processor 632 and main memory 636. I/O peripheral devices often include speaker systems 652, graphics devices 654, and other I/O devices 644 such as display monitors, keyboards, mouse-type input devices, floppy and hard disk drives, DVD drives, CD-ROM drives, and printers. Many computer systems also include network capability, terminal devices, modems, televisions, sound devices, voice recognition devices, electronic pen devices, and mass storage devices such as tape drives. The number of devices available to add to personal computer systems continues to grow, however computer system 630 may include fewer components than shown in FIG. 6 and described herein. The peripheral devices usually communicate with processor 632 over one or more busses 634, 656, 658, with the buses communicating with each other through the use of one or more bridges 660, 662.

Those of skill in the art will recognize that, based upon the teachings herein, several modifications may be made to the embodiments shown in FIGS. 1-6. For example, those skilled in the art will recognize that data processing systems other than computer systems are incorporated in the spirit and scope of the invention.

While particular embodiments of the present invention have been shown and described, it will be recognized to those skilled in the art that, based upon the teachings herein, further changes and modifications may be made without departing from this invention and its broader aspects, and thus, the appended claims are to encompass within their scope all such changes and modifications as are within the true spirit and scope of this invention.

What is claimed is:

1. An integrated circuit, comprising:
a first conductor coupled to a first repeater; and
a second conductor adjacent to the first conductor, the second conductor coupled by a second repeater and a third repeater, the second repeater on the second conductor and the third repeater on the second conductor located on opposing sides of the first repeater on the first conductor wherein a location of the second repeater and a location of the third repeater on opposing sides of the first repeater reduces capacitive interference.

2. The integrated circuit as recited in claim 1, wherein the integrated circuit is the memory in a computer system.

3. The integrated circuit as recited in claim 1, wherein the integrated circuit is the central processing unit in a computer system.

4. An integrated circuit, comprising:
a first conductor coupled to a first repeater; and
a second conductor adjacent to the first conductor, the second conductor coupled by a second repeater and a third repeater, wherein the second repeater and third repeater on the second conductor are substantially equidistant from the first repeater on the first conductor wherein a location of the second repeater and a location of the third repeater on opposing sides of the first repeater reduces capacitive interference.

5. The integrated circuit as recited in claim 4, wherein the integrated circuit is the memory in a computer system.

6. The integrated circuit as recited in claim 4, wherein the integrated circuit is the central processing unit in a computer system.

7. A method for designing an integrated circuit, comprising:
positioning a first conductor, the first conductor coupled to a first repeater;
positioning a second conductor adjacent to the first conductor, the second conductor coupled by a second repeater and a third repeater; and
positioning the second repeater and the third repeater in a location substantially equidistant from the first repeater wherein positioning the second repeater and the third repeater substantially equidistantly from the first repeater reduces capacitive interference.

8. A method for designing an integrated circuit, comprising:
positioning a first conductor, the first conductor coupled to a first repeater;
positioning a second conductor adjacent to the first conductor, the second conductor coupled by a second repeater and a third repeater; and
positioning the second repeater and the third repeater on the second conductor on opposing sides of the first repeater on the first conductor wherein a position of the second repeater and a position of the third repeater on opposing sides of the first repeater reduce capacitive interference.

9. A method for manufacturing an integrated circuit, comprising:
positioning a first conductor, the first conductor coupled to a first repeater;
positioning a second conductor adjacent to the first conductor, the second conductor coupled by a second repeater and a third repeater; and
positioning the second repeater and the third repeater such that the second repeater and the third repeater are substantially equidistant from the first repeater wherein a position of the second repeater and a position of the third repeater on opposing sides of the first repeater reduce capacitive interference.

10. A method for manufacturing an integrated circuit, comprising:
positioning a first conductor, the first conductor coupled to a first repeater;
positioning a second conductor adjacent to the first conductor, the second conductor coupled by a second repeater and a third repeater; and
positioning the second repeater and the third repeater such that the second repeater and the third repeater on the second conductor are substantially equidistant from the first repeater on the first conductor wherein a position of the second repeater and a position of the third repeater on opposing sides of the first repeater reduce capacitive interference.

11. A computer system, comprising:
a central processing unit;
a memory; and
an integrated circuit, the integrated circuit comprising:
a first conductor coupled by a first repeater and a second repeater; and
a second conductor adjacent to the first conductor, the second conductor coupled to a third repeater, wherein the third repeater is substantially equidistant from the first repeater and second repeater wherein a position of the second repeater and a position of the third repeater substantially equidistant from the first repeater reduce capacitive interference.

12. A computer system, comprising:
a central processing unit;
a memory; and
an integrated circuit, the integrated circuit comprising:
a first conductor coupled by a first repeater; and
a second conductor adjacent to the first conductor, the second conductor coupled to a second repeater and to a third repeater, wherein the second repeater and the third repeater are on opposing sides of the first repeater wherein a position of the second repeater and a position of the third repeater on opposing sides of the first repeater reduce capacitive interference.

13. A computer system, comprising:
a memory; and
a central processing unit, the central processing unit comprising;
a first conductor coupled to a first repeater; and
a second conductor adjacent to the first conductor, the second conductor coupled by a second repeater and a third repeater, wherein the second repeater and the third repeater are substantially equidistant from the first repeater wherein a position of the second repeater and a position of the third repeater substantially equidistant from the first repeater reduce capacitive interference.

14. A computer system, comprising:
a memory; and
a central processing unit, the central processing unit comprising;
a first conductor coupled to a first repeater; and
a second conductor adjacent to the first conductor, the second conductor coupled by a second repeater and a third repeater, wherein the second repeater and the third repeater are located on opposing sides of the first repeater wherein a position of the second repeater and a position of the third repeater on opposing sides of the first repeater reduce capacitive interference.

15. A computer system, comprising:
a central processing unit; and
a memory, the memory comprising;
a first conductor coupled to a first repeater; and
a second conductor adjacent to the first conductor, the second conductor coupled by a second repeater and a third repeater, wherein the second repeater and the third repeater are substantially equidistant from the first repeater wherein a position of the second repeater and a position of the third repeater substantially equidistant from the first repeater reduce capacitive interference.

16. A computer system, comprising:
a central processing unit; and
a memory, the memory comprising;
a first conductor coupled to a first repeater; and
a second conductor adjacent to the first conductor, the second conductor coupled by a second repeater and a third repeater, wherein the second repeater and the third repeater are located on opposing sides of the first repeater wherein a position of the second repeater and a position of the third repeater on opposing sides of the first repeater reduce capacitive interference.

17. A computer system, comprising:
a central processing unit;
a memory; and
an integrated circuit, the integrated circuit comprising;
a first conductor coupled to a first repeater; and
a second conductor adjacent to the first conductor, the second conductor coupled by a second repeater and a third repeater, wherein the second repeater and the third repeater are located on opposing sides of the first repeater wherein a position of the second repeater and a position of the third repeater on opposing sides of the first repeater reduce capacitive interference.

18. A computer system, comprising:
a central processing unit;
a memory; and
an integrated circuit, the integrated circuit comprising;
a first conductor coupled to a first repeater; and
a second conductor adjacent to the first conductor, the second conductor coupled by a second repeater and a third repeater, wherein the second repeater and the third repeater are located on opposing sides of the first repeater wherein a position of the second repeater and a position of the third repeater on opposing sides of the first repeater reduce capacitive interference.

19. An electrical circuit, the electrical circuit designed to reduce capacitive interference, the circuit comprising:
a first conductor coupled to a first repeater; and
a second conductor adjacent to the first conductor, the second conductor coupled by a second repeater and a third repeater, wherein the second repeater and the third repeater are located on opposing sides of the first repeater wherein a position of the second repeater and a position of the third repeater on opposing sides of the first repeater reduce capacitive interference.

20. An electrical circuit, the electrical circuit designed to reduce capacitive interference, the circuit comprising:
a first conductor coupled to a first repeater; and
a second conductor adjacent to the first conductor, the second conductor coupled by a second repeater and a third repeater, wherein the second repeater and the third repeater are located substantially equidistant from the first repeater wherein a position of the second repeater and a position of the third repeater substantially equidistant from the first repeater reduce capacitive interference.

21. A method for designing an electrical circuit to reduce capacitive interference, the method comprising:
positioning a first conductor, the first conductor is coupled to a first repeater;
positioning a second conductor adjacent to the first conductor, the second conductor coupled by a second repeater and a third repeater; and
positioning the second repeater and the third repeater are substantially equidistant from the first repeater wherein a position of the second repeater and a position of the third repeater substantially equidistant from the first repeater reduce capacitive interference.

22. A method for designing an electrical circuit to reduce capacitive interference, the method comprising:
positioning a first conductor, the first conductor coupled to a first repeater;
positioning a second conductor adjacent to the first conductor, the second conductor coupled by a second repeater and a third repeater; and
positioning the second repeater and the third repeater such that the second repeater and the third repeater are located on opposing sides of the first repeater wherein a position of the second repeater and a position of the third repeater on opposing sides of the first repeater reduce capacitive interference.

23. A method for manufacturing an electrical circuit to reduce capacitive interference, the method comprising:
positioning a first conductor, the first conductor is coupled to a first repeater;
positioning a second conductor adjacent to the first conductor, the second conductor coupled by a second repeater and a third repeater; and
positioning the second repeater and the third repeater are substantially equidistant from the first repeater wherein a position of the second repeater and a position of the third repeater substantially equidistant from the first repeater reduce capacitive interference.

24. A method for manufacturing an electrical circuit to reduce capacitive interference, the method comprising:
positioning a first conductor, the first conductor coupled to a first repeater;
positioning a second conductor adjacent to the first conductor, the second conductor coupled by a second repeater and a third repeater; and
positioning the second repeater and the third repeater such that the second repeater and the third repeater are located on opposing sides of the first repeater wherein a position of the second repeater and a position of the third repeater on opposing sides of the first repeater reduce capacitive interference.

25. An integrated circuit, wherein the integrated circuit is designed to reduce the Miller effect of capacitive interference, comprising:
a first conductor coupled to a first repeater; and
a second conductor adjacent to the first conductor, the second conductor coupled by a second repeater and a third repeater, where in the second repeater and the third repeater are substantially equidistant from the first repeater wherein a position of the second repeater and a position of the third repeater substantially equidistant from the first repeater reduce capacitive interference.

26. An integrated circuit, wherein the integrated circuit is designed to reduce the Miller effect of capacitive interference, comprising:
a first conductor coupled to a first repeater; and
a second conductor adjacent to the first conductor, the second conductor coupled by a second repeater and a third repeater, where in the second repeater and the third repeater are located on opposing sides of the first conductor wherein a position of the second repeater and a position of the third repeater on opposing sides of the first repeater reduce capacitive interference.

27. A method for designing an integrated circuit to reduce the Miller effect of capacitive interference, comprising:
positioning a first conductor, the first conductor is coupled to a first repeater;
positioning a second conductor adjacent to the first conductor, the second conductor coupled by a second repeater and a third repeater; and
positioning the second repeater and the third repeater substantially equidistant from the first repeater wherein a position of the second repeater and a position of the third repeater substantially equidistant from the first repeater reduce capacitive interference.

28. A method for designing an integrated circuit to reduce the Miller effect of capacitive interference, comprising:
positioning a first conductor, the first conductor is coupled to a first repeater;
positioning a second conductor adjacent to the first conductor, the second conductor coupled by a second repeater and a third repeater; and
positioning the second repeater and the third repeater on opposing sides of the first repeater wherein a position of the second repeater and a position of the third repeater on opposing sides of the first repeater reduce capacitive interference.

29. A method for manufacturing an integrated circuit to reduce the Miller effect of capacitive interference, comprising:
positioning a first conductor, the first conductor coupled to a first repeater;
positioning a second conductor adjacent to the first conductor, the second conductor coupled by a second repeater and a third repeater; and
positioning the second repeater and the third repeater such that the second repeater and the third repeater are substantially equidistant from the first repeater wherein a position of the second repeater and a position of the third repeater substantially equidistant from the first repeater reduce capacitive interference.

30. A method for manufacturing an integrated circuit to reduce the Miller effect of capacitive interference, comprising:
positioning a first conductor, the first conductor coupled to a first repeater;
positioning a second conductor adjacent to the first conductor, the second conductor coupled by a second repeater and a third repeater; and
positioning the second repeater and the third repeater such that the second repeater and the third repeater are on opposing sides of the first repeater wherein a position of the second repeater and a position of the third repeater on opposing sides of the first repeater reduce capacitive interference.
